(19) United States
(12) Patent Application Publication
(10) Pub. No.: US 2005/0106349 A1
(43) Pub. Date: May 19, 2005

(54) Adhesive napkin assembly

(76) Inventor: Jenelle Bonifield, Scottsdale, AZ (US)

Correspondence Address: ETHERTON LAW GROUP, LLC, 5555 E. VAN BUREN STREERT, SUITE 100, PHOENIX, AZ, 85008, US

(21) Appl. No.: 10/718,224

(22) Filed: Nov. 19, 2003

(51) Int. Cl. B32B 9/00

(52) U.S. Cl. 428/40.1; 428/43

(57) ABSTRACT

An assembly of adhesive napkins. The preferred embodiment is a length of flexible material which has been perforated at spaced intervals. Repositionable adhesive is applied to the material, preferably by spraying, along one edge. The length is rolled onto itself to form an assembly such that one sheet can be separated from the length by tearing the length along the perforations. In alternate embodiments, the adhesive is perpendicular to the edge, near the perforations and deformable perforations separate interconnected lands of adhesive.

### FIELD OF INVENTION

This invention relates generally to an assembly of napkins that have repositionable adhesive. This invention relates more particularly to napkins having adhesive along one edge which are dispensed one at a time from a roll or stack.

### BACKGROUND

Keeping your napkin on your lap has been a problem since napkins were invented. Gentlemen, waiters, parents and maitre d's have made careers of retrieving napkins from the floor and replacing them on diners' laps. To alleviate this problem, inventors have come up with a cornucopia of ways to secure the napkin to the lap. An early patent, U.S. Pat. No. 2,009,831 issued to Yerzley in 1935, simply incorporated a piece of cellophane tape onto a paper napkin which made it possible to stick the napkin to the person's clothing. Apparently a small patch adhesive was insufficient to make the idea stick in the mind of consumers, however, because Honig invented the use of a strip of adhesive, as disclosed in U.S. Pat. No. 3,978,553 and, more recently, Bellander disclosed reinforced adhesive tabs in U.S. Pat. No. 5,476,697. Still, it seemed, adhesive napkins weren't taking hold commercially.

Apparently the adhesive napkins were difficult to manufacture and package: if a napkin used strong enough adhesive to make the napkin stick to the person's clothing, the adhesive would also permanently stick to the adjacent tissue. This made the napkin difficult to package and deploy. Numerous later patents disclosed attempts to improve these problems by incorporating various means for covering the adhesive until it was time for use. In U.S. Pat. No. 2,803,574 Payant disclosed a napkin with adhesive on one corner and a non-stick surface on a complementary corner, so that the napkin could be folded and stored without sticking to itself. In U.S. Pat. No. 2,902,734 Walters disclosed the use of an adhesive tab that folds back upon itself. The user pulls on the ends of the tab to expose the adhesive. Fried again tries to solve the napkin storage problem in U.S. Pat. Nos. 3,398,438 and 3,398,439 by providing a non-stick flap the covers the adhesive so that the napkins can stored without irretrievably sticking to each other. In U.S. Pat. No. 5,468,534, Godfrey added a clip to the adhesive tab, and dispensed the napkins vertically from a box. While avoiding the self-stick problem, these complex napkins were impractical for parents trying to teach children how to properly use a napkin amidst the dinnertime chaos. Further, the complex packaging and deployment contrivances increased costs of production and made adhesive napkins prohibitively expensive for use on a daily basis.

The simple idea of adhesive napkins has gotten gummed up with such complications that they have not achieved widespread acceptance. What is needed is an adhesive napkin that can be made relatively simply and dispensed conveniently. Therefore, it is an object of this invention to provide an assembly of adhesive napkins that can be packaged without irretrievable sticking to each other. It is a further object of this invention to provide an assembly of napkins that conveniently dispenses the napkins one at a time. It is another object to provide a straightforward method of manufacturing adhesive napkins.

### SUMMARY OF THE INVENTION

The present invention is an assembly of adhesive napkins that do not irretrievably stick to themselves, yet adhere sufficiently to stay on a person's lap while dining. The preferred embodiment is a length of tissue which has been perforated at spaced intervals. Repositionable adhesive is applied to the material along one edge, preferably by spraying. The length is rolled onto itself to form an assembly such that one sheet can be separated from the length by tearing the length along the perforations. Alternatively, the adhesive is perpendicular to the edge, near the perforations. In alternate embodiments, the assembly is a stack of napkins with repositionable adhesive along an edge and deformable perforations separate interconnected lands of adhesive.

### BRIEF DESCRIPTION OF THE DRAWINGS

FIG. 1 is a view of the bottom of a napkin with adhesive near an edge.

FIG. 2 is a view of the bottom of a napkin with adhesive near a contoured edge.

FIG. 3 is a perspective view of a roll of adhesive napkins with adhesive near the perforation.

FIG. 4 is a perspective view of a roll of adhesive napkins with adhesive near an edge.

FIG. 5 is a perspective view of a stack of interleaved adhesive napkins, shown lifted apart to better illustrate how they are interleaved.

FIG. 6 is a perspective view of a stack of adhesive napkins.

FIG. 7 is a perspective view of an alternate embodiment of a stack of adhesive napkins.

FIG. 8 is a schematic illustration of a solution containing adhesive being sprayed on a sheet of material.

FIG. 9 is a top view of an alternative embodiment involving pressure sensitive adhesive between thermoformed protrusions.

FIG. 10 is a cross-sectional view of the alternative embodiment involving pressure sensitive adhesive between thermoformed protrusions.

### DETAILED DESCRIPTION OF THE INVENTION

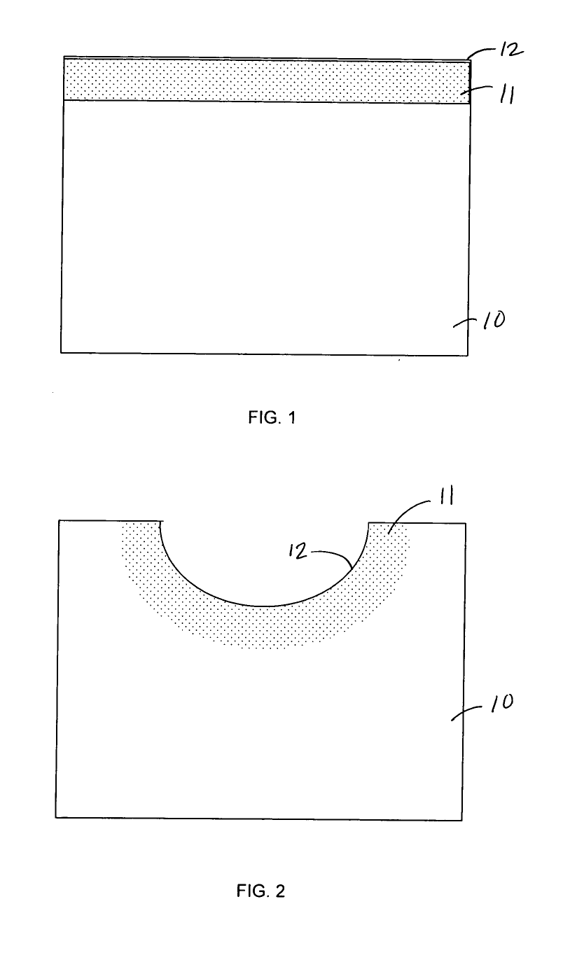

FIG. 1 illustrates an adhesive napkin, referred to generally as 10. Each napkin 10 is made of a sheet of flexible material such as paper, plastic, or cloth, or a combination of such materials. In the preferred embodiment, the material is tissue paper sufficiently absorbent and strong to perform as a napkin, either single or multi-ply. The napkin may also be lined with an impermeable barrier opposite an absorbent side. FIG. 2 illustrates a napkin contoured to comfortably fit around a person's neck, which may be particularly useful for a child's bib or a dental bib. The sheet material may take on a variety of shapes and sizes, depending on which part of a person's body needs to be covered.

Pressure-sensitive adhesive 11 is applied to one side of the napkin 10. Although it could be applied all over the one side of napkin 10, the adhesive 11 is preferably applied as a band generally near an edge 12 of the napkin 10, where near also encompasses the edge and the area adjacent to the edge. The adhesive may be applied in stripes, squares, discontiguous spots, amorphous patterns, random patterns, tiled, etc. Regardless of the applied geometry, the adhesive should adhere to fabric sufficiently so that the napkin will stick to a person's clothing while dining, yet be releasable when the diner wants to remove the napkin. Furthermore, the adhesive must be releasable upon contact with itself and the napkin, without tearing the napkin. This quality of adhering and being releasable is referred to herein as being repositionable. Repositionable adhesive is known, particularly as it is applied to paper. See, for example, the elastomeric copolymers used by 3M on its Post-It® stationery products and disclosed in a series of patents including U.S. Pat. No. 3,691,140, U.S. Pat. No. 3,857,731 and progeny. For certain applications, the adhesive may be covered with a removable liner that adheres to the adhesive but does not adhere to the sheet material.

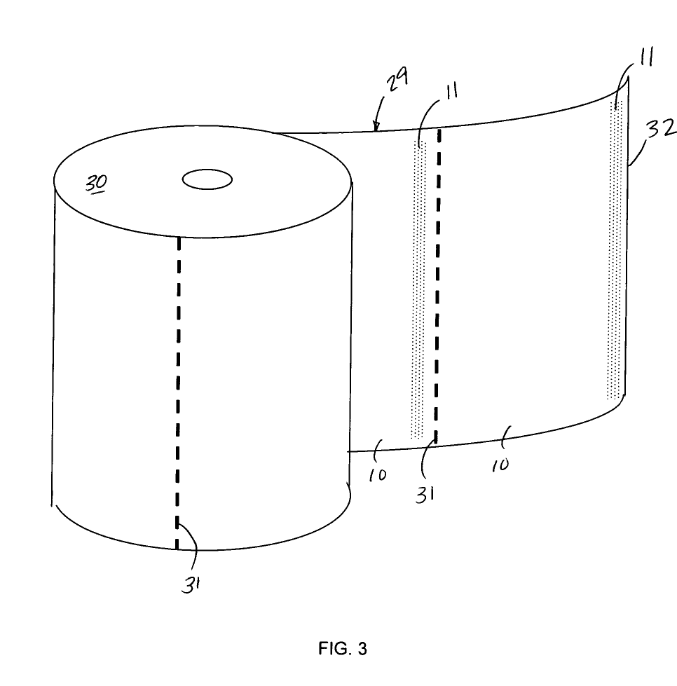

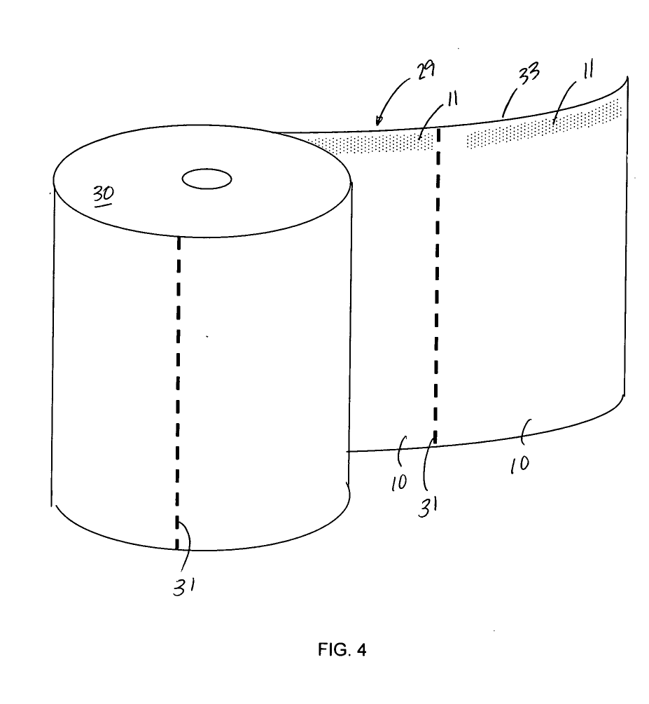

FIG. 3 illustrates the preferred embodiment, namely a roll 30 of adhesive napkins. The roll 30 comprises a sheet 29 of flexible material, with perforations 31 at spaced intervals, that is rolled upon itself to create a roll of napkins 10 that are separable by tearing the perforations, thus dispensing one at a time. Repositionable adhesive 11 is applied to one side of the napkin 10. The adhesive 11 is applied as a band near an edge 32 of the napkin 10, preferably near the perforations 31. FIG. 4 shows an alternate embodiment with the adhesive applied near the first edge 33 of the flexible sheet 29. Additional adhesive may be applied, for example on the edge opposite the first edge.

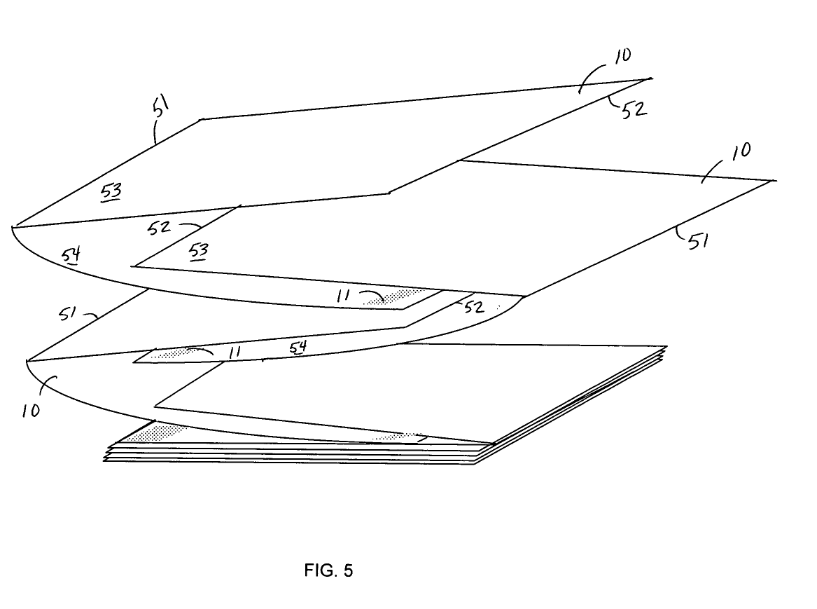

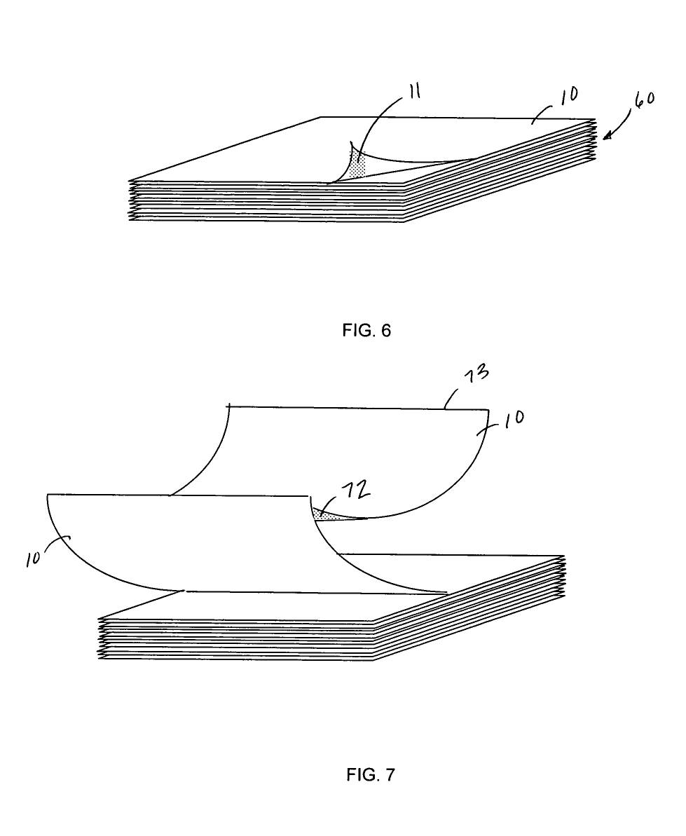

FIGS. 5, 6, and 7 illustrate additional embodiments, which enable adhesive napkins to be packaged together and dispensed one at a time. In FIG. 5, each napkin 10 has at least one fold 51 parallel to a first edge 52, which divides the napkin into a first section 53 and a second section 54. Repositionable adhesive 11 is applied to one side of the napkin, preferably near the first edge 52. One napkin is interleaved with the next, forming an interleaved stack in which as the first section 53 of one napkin is lifted, it is separated from the next napkins and at the same time, its second section 54 lifts a first section 53 of the successive napkin. FIG. 6 illustrates a stack 60 of adhesive napkins. Each napkin 10 has adhesive 11 near one edge, and the adhesive edges are aligned such that the adhesive edge of one sheet is in contact with the top of another sheet at its adhesive edge and the edges of each sheet are in substantial alignment with edges of all other sheets. FIG. 7 illustrates a pull-up stack 70 of adhesive napkins. Each napkin 10 has adhesive 11 near one edge 72, which is opposite an edge without adhesive 73. The napkins 10 are placed one upon the other to form a pull-up stack, the adhesive edge 72 of one napkin 10 in contact with the top of another napkin 10 near the edge lacking adhesive 73. The adhesive and non-adhesive edges are in substantial alignment with the non-adhesive and adhesive edges of all other sheets, alternately, whereby lifting one sheet from the stack lifts the edge of the successive sheet.

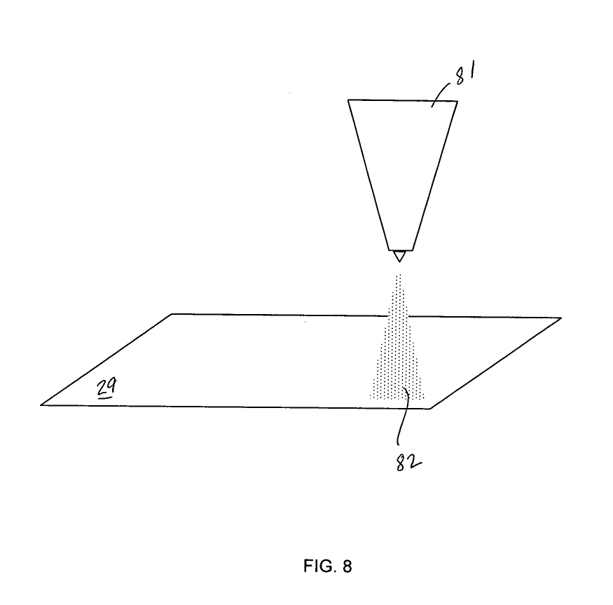

In the preferred embodiment, the adhesive is applied to the sheet by spraying a solution or dispersion of a normally tacky and pressure-sensitive adhesive in a liquid carrier on the sheet, and thereafter evaporating the liquid carrier, leaving a non-repetitive discontinuous pattern of spaced islands of adhesive. FIG. 8 illustrates a plan view of a spray head 81 and the adhesive spray 82 emanating therefrom. Methods of spraying adhesive are known in the art, as exemplified by the process disclosed in U.S. Pat. No. 5,194,299.

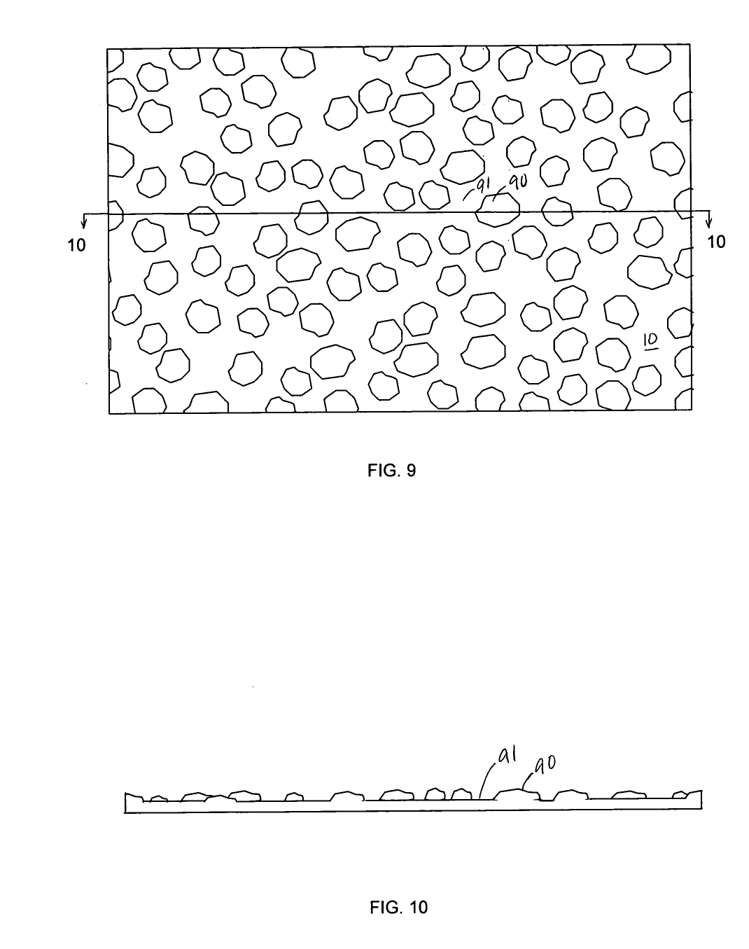

In an alternative embodiment, napkin 10 may also have thermoformed protrusions 90 extending from the napkin surface, with pressure sensitive adhesive 91 in the interconnected lands between the protrusions, as shown in FIG. 9 and FIG. 10. The protrusions prevent adhesion of the napkin to itself or to another surface until the napkin is pressed against the clothing. Each protrusion may be conical, domed or mesa shaped. The height of the protrusion is preferably less than the diameter of the protrusion, so that when pressed, the protrusion will collapse in a direction substantially perpendicular to the plane of the napkin. Pressing collapses the protrusions locally to expose the adhesive and enable it contact and stick to the clothing. The adhesive is repositionable so that the material may be peeled away from the clothing such that the adhesive stays with the material. The material can then be repositioned on another portion of clothing.

While there has been illustrated and described what is at present considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

1. A napkin comprising:
a) a sheet of flexible material having a top, a bottom and a first edge; and
b) repositionable adhesive on the bottom of the sheet.

2. The napkin of claim 1 wherein the repositionable adhesive is applied to the sheet by spraying a solution or dispersion of a normally tacky and pressure-sensitive adhesive in a liquid carrier and thereafter evaporating the liquid carrier, leaving a non-repetitive discontinuous pattern of spaced islands of adhesive.

3. The napkin of claim 2 further comprising a removable liner that adheres to the adhesive but does not adhere to the sheet.

4. The napkin of claim 1 wherein the sheet has a plurality of protrusions extending from the bottom near the first edge and adhesive between the protrusions such that when the protrusions are collapsed, the adhesive is exposed.

5. The napkin of claim 1 further comprising a plurality of sheets which are placed one upon the other to form a stack, wherein the adhesive is applied near the first edge of each sheet, the bottom of each sheet is in contact with the top of another sheet, and the first edges of each sheet are in substantial alignment with the first edges of all other sheets.

6. An assembly of adhesive napkins dispensable one at a time comprising:
a) a length of flexible material having a top, a bottom, and a first edge opposite a second edge, the length perforated at spaced intervals between the first edge and the second edge to define a plurality of sheets; and
b) repositionable adhesive on the bottom of each sheet;
wherein the length of material is rolled upon itself to form a roll from which one sheet can be separated from the length by tearing the length along the perforations.

7. The assembly of claim 6 wherein the adhesive is applied near the first edge.

8. The assembly of claim 6 wherein the adhesive is applied near the perforation.

9. The assembly of claim 6 wherein the adhesive is applied to the sheet by spraying a solution or dispersion of a normally tacky and pressure-sensitive adhesive in a liquid carrier and thereafter evaporating the liquid carrier, leaving a non-repetitive discontinuous pattern of spaced islands of adhesive.

10. The assembly of claim 6 further comprising a removable liner that adheres to the adhesive but does not adhere to the sheet.

11. The assembly according to claim 6 wherein the length of material has a plurality of protrusions extending from the bottom and adhesive between the protrusions such that when the protrusions are collapsed, the adhesive is exposed.

12. An assembly of adhesive napkins dispensable one at a time comprising:
a) a plurality of sheets of flexible material, each sheet having a top, a bottom, and a first edge opposite a second edge, and each sheet having at least one fold parallel to the first edge which divides the sheet into a first section and a second section;
b) repositionable adhesive on the bottom of each sheet;
wherein the plurality of sheets are interleaved one upon the other to form a stack, the first and second edges of each sheet in substantial alignment with the first and second edges of all other sheets, respectively, such that lifting one sheet from the stack separates it from the stack and lifts the first section of the successive sheet.

13. The assembly of claim 12 wherein the adhesive is applied near the first edge.

14. The assembly of claim 12 wherein the adhesive is applied substantially perpendicularly to the first edge.

15. The assembly of claim 12 wherein the adhesive is applied to the sheet by spraying a solution or dispersion of a normally tacky and pressure-sensitive adhesive in a liquid carrier and thereafter evaporating the liquid carrier, leaving a non-repetitive discontinuous pattern of spaced islands of adhesive.

16. The assembly according to claim 12 wherein each sheet further comprises a plurality of protrusions extending from the bottom and adhesive between the protrusions such that when the protrusions are collapsed, the adhesive is exposed.

17. An assembly of adhesive napkins dispensable one at a time comprising:
a) a plurality of sheets of flexible material, each sheet having a top, a bottom, and a first edge opposite a second edge;
b) repositionable adhesive on the bottom of each sheet, the repositionable adhesive applied to each sheet by spraying a solution or dispersion of a normally tacky and pressure-sensitive adhesive in a liquid carrier and thereafter evaporating the liquid carrier, leaving a non-repetitive discontinuous pattern of spaced islands of adhesive;
wherein the plurality of sheets are placed one upon the other to form a stack, the adhesive of one sheet in contact with the top of another sheet and the edges of each sheet in substantial alignment with the first edges of all other sheets.

18. An assembly of adhesive napkins dispensable one at a time comprising:
a) a plurality of sheets of flexible material, each sheet having a top, a bottom, and a first edge opposite a second edge;
b) repositionable adhesive on the bottom of each sheet near its first edge;
wherein the plurality of sheets are placed one upon the other to form a stack, the adhesive of one sheet in contact with the top of another sheet and the first and second edges of each sheet in substantial alignment with the second and first edges of all other sheets, alternately, whereby lifting one sheet from the stack lifts the second edge of the successive sheet.

19. The assembly of claim 18 wherein the repositionable adhesive is applied to each sheet by spraying a solution or dispersion of a normally tacky and pressure-sensitive adhesive in a liquid carrier and thereafter evaporating the liquid carrier, leaving a non-repetitive discontinuous pattern of spaced islands of adhesive.

20. A napkin comprising:
a) a sheet of continuous, flexible absorbent material having a plurality of protrusions extending therefrom, the sheet further having a first edge; and
b) repositionable adhesive between the protrusions such that when the protrusions are collapsed, the adhesive is exposed.

21. The napkin of claim 22 further comprising a plurality of sheets which are placed one upon the other to form a stack, the bottom of each sheet is in contact with the top of another sheet, the first edges of each sheet are in substantial alignment with the first edges of all other sheets, and the first edges of the plurality of sheets are pressed together so that they adhere to each other.

22. The napkin according to claim 22 wherein the sheet of material further comprises a top, a bottom, and a second edge opposite the first edge, the sheet perforated at spaced intervals between the first edge and the second edge to define a plurality of portions; and the sheet is rolled upon itself to form a roll from which one portion can be separated from the sheet by tearing the sheet along the perforations.

23. The napkin of claim 22 further comprising:
a) a plurality of sheets, each sheet having a top, a bottom, and a second edge opposite the first edge; and
b) each sheet having at least one fold parallel to the first edge which divides the sheet into a first section and a second section; and wherein the plurality of sheets are interleaved one upon the other to form a stack, the first and second edges of each sheet in substantial alignment with the first and second edges of all other sheets, respectively, such that lifting one sheet from the stack separates it from the stack and lifts the first section of the successive sheet.

24. The napkin of claim 22 further comprising a plurality of sheets, each sheet having a top, a bottom, and a second edge opposite the first edge; wherein the plurality of sheets are placed one upon the other to form a stack, the adhesive of one sheet in contact with the top of another sheet and the first and second edges of each sheet in substantial alignment with the second and first edges of all other sheets, alternately, whereby lifting one sheet from the stack lifts the second edge of the successive sheet.

25. A method of making an assembly of adhesive napkins comprising:
a) spraying a solution or dispersion of a normally tacky and pressure-sensitive adhesive in a liquid carrier onto a length of flexible material;
b) evaporating the liquid carrier, leaving a non-repetitive discontinuous pattern of spaced islands of adhesive on the sheet; and
c) perforating the length of flexible material at spaced intervals;
d) and rolling the length of flexible material into a roll;
wherein one sheet can be separated from the length by tearing the length along the perforations.

26. A method of making an assembly of adhesive napkins comprising:
a) spraying a solution or dispersion of a normally tacky and pressure-sensitive adhesive in a liquid carrier onto a sheet of flexible material;
b) evaporating the liquid carrier, leaving a non-repetitive discontinuous pattern of spaced islands of adhesive on the sheet; and
c) collating the sheets into a stack.

27. The method according to claim 26 further comprising:
a) folding the sheet parallel to the first edge which divides the sheet into a first section and a second section;
b) wherein collating further comprises interleaving one sheet upon the other to form the stack, the first and second edges of each sheet in substantial alignment with the first and second edges of all other sheets, respectively, such that lifting one sheet from the stack lifts the first section of the successive sheet.
